(19) United States
(12) Patent Application Publication
(10) Pub. No.: US 2023/0052117 A1
(43) Pub. Date: Feb. 16, 2023

(54) APPARATUS AND METHOD FOR UPDATING UE PARAMETERS BASED ON CONTROL PLANE

(71) Applicant: ELECTRONICS AND TELECOMMUNICATIONS RESEARCH INSTITUTE, Daejeon (KR)

(72) Inventors: Jihoon SUNG, Daejeon (KR); Soohwan LEE, Daejeon (KR); Myung Ki SHIN, Daejeon (KR)

(73) Assignee: ELECTRONICS AND TELECOMMUNICATIONS RESEARCH INSTITUTE, Daejeon (KR)

(21) Appl. No.: 17/885,036

(22) Filed: Aug. 10, 2022

(30) Foreign Application Priority Data
Aug. 10, 2021 (KR) 10-2021-0105657
Jan. 27, 2022 (KR) 10-2022-0012571
Aug. 9, 2022 (KR) 10-2022-0099525

(51) Int. Cl. H04W 48/18; H04W 8/08; H04W 28/02; H04W 76/10

(52) U.S. Cl. CPC H04W 48/18; H04W 8/08; H04W 28/0268; H04W 76/10; H04W 80/08

(57) ABSTRACT

A unified data management function (UDM) in a communication system including: a processor, a memory, and a communication device, wherein the processor executes a program stored in the memory to perform: determining an update of a UE parameter of a terminal to update the UE parameter and notifying the updated UE parameter to an AMF connected to the terminal by invoking a service operation for an SDM notification is provided.

### CROSS-REFERENCE TO RELATED APPLICATION

This application claims priority to and the benefit of Korean Patent Application No. 10-2021-0105657 filed in the Korean Intellectual Property Office on Aug. 10, 2021, Korean Patent Application No. 10-2022-0012571 filed in the Korean Intellectual Property Office on Jan. 27, 2022, and Korean Patent Application No. 10-2022-0099525 filed in the Korean Intellectual Property Office on Aug. 9, 2022, the entire contents of which are incorporated herein by reference.

### BACKGROUND OF THE INVENTION

### (a) Field of the Invention

This description relates to a method and apparatus for updating parameters of user equipment using a control plane.

### (b) Description of the Related Art

In the 5G system, the network functions of the core network can update predetermined parameters in the terminal.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments provide a unified data management function in a communication system.

Embodiments provide a terminal in a communication system.

According to an embodiment, a unified data management function (UDM) in a communication system is provided. In such an embodiment, the UDM includes: a processor, a memory, and a communication device, wherein the processor executes a program stored in the memory to perform: determining an update of at least one UE parameter of a terminal and updating the UE parameter; and notifying the updated UE parameter to an access and mobility management function (AMF) connected to the terminal by invoking a service operation for a subscription data management (SDM) notification of the UDM.

In an embodiment, when determining the update of the UE parameter of the terminal, the processor may perform detecting a change of a slice available for the terminal and determining to perform an update of slice-related credentials.

In an embodiment, the slice-related credentials may include a network slice-specific authentication and authorization (NSSAA) credentials per single-network slice selection assistance information (S-NSSAI).

In an embodiment, when determining the update of the UE parameter of the terminal, the processor may perform detecting a change of a data network (DN) allowed for the terminal and determining to perform an update of DN-related credentials.

In an embodiment, the DN-related credentials may include DN-specific credentials and the DN-specific credentials may be credentials for authentication/authorization of a protocol data unit (PDU) session establishment for a predetermined DN used by the terminal.

According to another embodiment, a terminal in a communication system is provided. In such an embodiment, the terminal includes: a processor, a memory, and a communication device, wherein the processor executes a program stored in the memory to perform: receiving update data of at least one UE parameter including updated slice-related credentials from an access and mobility management function (AMF) of a core network in the communication system; and receiving a service from the core network based on the update data.

In an embodiment, when receiving the service from the core network based on the update data, the processor may perform requesting re-registration to the AMF.

In an embodiment, the processor may execute the program to further perform transmitting an acknowledgment for the update data to a unified data management function (UDM) of the core network via the AMF.

In an embodiment, the slice-related credentials may include network slice-specific authentication and authorization (NSSAA) credentials per single NSSAI (S-NSSAI).

In an embodiment, the processor may execute the program to further perform receiving an acceptance for the request of the re-registration from the AMF.

In an embodiment, requested network slice selection assistance information (requested NSSAI) included in the request of the re-registration may correspond to the slice-related credentials.

According to yet another embodiment, a terminal in a communication system is provided. In such an embodiment, the terminal include a processor, a memory, and a communication device, wherein the processor executes a program stored in the memory to perform: receiving update data of at least one UE parameter including updated data network (DN)-related credentials from an access and mobility management function (AMF) of a core network in the communication system; and receiving a service from the core network based on the update data.

In an embodiment, the processor may execute the program to further perform transmitting an acknowledgment for the update data to a unified data management function (UDM) of the core network via the AMF.

In an embodiment, the DN-related credentials may include DN-specific credentials for authentication/authorization of protocol data unit (PDU) session establishment for a predetermined DN used by the terminal.

In an embodiment, when receiving the service from the core network based on the update data, the processor may perform transmitting a request for authentication/authorization of the PDU session establishment to the DN corresponding to the DN-related credentials.

In an embodiment, when receiving the service from the core network based on the update data, the processor may perform requesting re-registration to the AMF.

In an embodiment, the processor may execute the program to further perform receiving an acceptance for the request of the re-registration from the AMF.

### BRIEF DESCRIPTION OF THE DRAWINGS

FIG. 1 is a flowchart illustrating a method for updating UE parameters according to an embodiment.

FIG. 2 is a block diagram illustrating a network function according to an embodiment.

### DETAILED DESCRIPTION OF THE EMBODIMENTS

In the following detailed description, only certain embodiments of the present invention have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a terminal may be called user equipment (UE), mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a macro base station (macro BS), a micro base station (micro BS), and the like), and the like and may also include all or some of the functions of the ABS, the node B, the eNodeB, the AP, the RAS, the BTS, the MMR-BS, the RS, the RN, the ARS, the HR-RS, the small base stations, and the like.

In this specification, unless explicitly described to the contrary, the word “comprises”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

As used herein, “A or B”, “at least one of A and B”, “at least one of A or B”, “A, B, or C”, “at least one of A, B, and C”, and “at least one of A , B, or C” each may include any one of, or all possible combinations of, items listed together in the corresponding one of the phrases.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

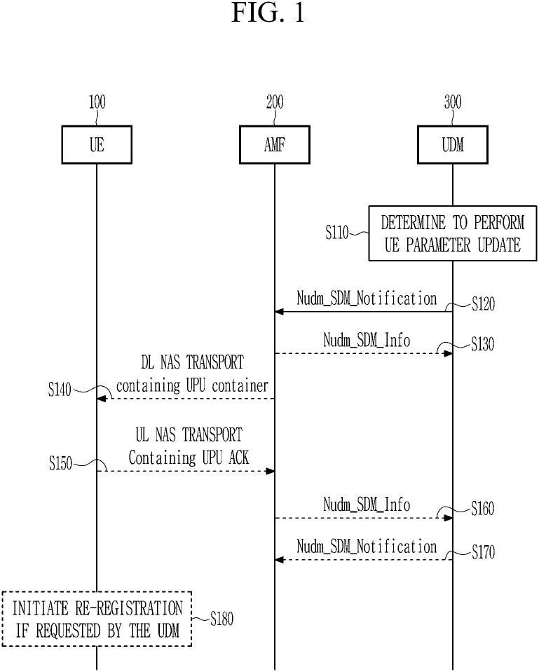

FIG. 1 is a flowchart illustrating a method for updating UE parameters according to an embodiment.

In an embodiment, a core network in a 5G system may update a set of parameters in user equipment (UE) (that is, UE parameters) by using a control plane solution. The UE parameters that the core network updates through the control plane may be a specific set of parameters and the specific set of parameters may be generated and stored in a unified data management function (UDM). The core network may update the UE parameters by delivering protected UDM update data via NAS (Non-Access Stratum) signaling to the UE.

The core network that can update the UE parameters may include Home Public Land Mobile Network (HPLMN), Stand-alone Non-Public Network (SNPN), Credentials Holder (CH).

The HPLMN, SNPN, or CH may update the UE parameters based on the operator policies.

The UE parameters updated by the HPLMN, SNPN, or CH may include the following.
The updated Default Configured Network Slice Selection Assistance Information (NSSAI) (the final consumer of the parameter is mobile equipment (ME))
Slice-related credentials (e.g., Network Slice-Specific Authentication and Authorization (NSSAA) credentials per single-NSSAI (S-NSSAI) (the final consumer of the parameter is the ME or a Universal Subscriber Identify Module (USIM))
Data network (DN)-related credentials (e.g., DN-specific credentials for authentication/authorization of protocol data unit (PDU) session establishment (the final consumer of the parameter is the ME or the USIM))
List for SNPN selection when the CH is an SNPN (the final consumer of the parameter is the ME)
The updated Routing Indicator Data (the final consumer of the parameter is the USIM when PLMN or SNPN credentials are stored in the USIM; or the final consumer of the parameter is the ME when SNPN credentials are stored in the ME)
a “UE acknowledgment requested” indication
“re-registration requested” indication
“Enable disaster roaming” indication

Referring to FIG. 1, the UDM 300 may determine to perform the update of the UE parameter and update the UE parameter S110.

In an embodiment, the UDM 300 may detect a change in a slice that the UE 100 can use and determine an update of slice-related credentials. For example, when the UE 100 needs to use a slice different from the slice used outside the SNPN in the SNPN, the UDM 300 in the SNPN may determine an update of credentials for the slice that can be used by the UE 100 in the corresponding SNPN. The SNPN may provide different levels of service for each UE 100, and a slice may be determined according to the level of the service to be provided by the UE 100. When the level of the service to be provided to the UE 100 is changed or predicted to be changed, the UDM 300 in the SNPN may determine to update the slice-related credentials accordingly.

For example, when the UE 100 can use a slice that guarantees better QoS within the SNPN, the UDM 300 in the SNPN may update the slice-related credentials so that the UE 100 can receive the service via the slice that provides a higher level of service. Alternatively, when the level of slices that the UE 100 can use in the SNPN is limited, the UDM 300 in the SNPN may limit the slices that the UE 100 can use by updating the slice-related credentials.

In an embodiment, when a DN allowed to the UE 100 by the SNPN is changed or predicted to be changed, the UDM 300 may determine to update DN-related credentials (e.g., DN-specific credentials). That is, the UDM 300 may detect a change in the DN to which the UE 100 is allowed to access and determine to update the DN-related credentials (or DN-specific credentials).

For example, when a DN allowed to the UE 100 is added, the UDM 300 may allow the UE 100 to access the added DN by updating the DN-related credentials. Alternatively, the UDM 300 may restrict the UE 100 from accessing a specific DN (pre-determined DN) through the update of the DN-related credentials. Here, the DN-related credentials or the DN-specific credentials may be credentials for authentication/authorization of PDU session establishment toward the DN.

The UDM 300 may notify an access and mobility management function (AMF) 200 in the core network of a change of the information related to the UE 100 (e.g., the change of the UE parameter) by invoking Nudm_ SDM_Notification service operation (S120). The AMF 200 may be an AMF connected to the UE 100 and affected by the update of the UE parameters. The Nudm_SDM_Notification service operation is a service operation used by the UDM 300 for a subscription data management (SDM) notification service.

The Nudm_SDM_Notification service operation may include UDM update data (the updated UE parameter or data related to the updated UE parameter) that needs to be transparently delivered to the UE 100 over a non-access stratum (NAS) layer. The UDM update data may be included in access and mobility subscription data.

The UDM update data may include the following.
The updated parameters to be delivered to the UE
Whether the UE needs to send an acknowledgment (ack) for updating the data to the UDM
Whether the UE needs to re-register after updating the data (UE parameter)

In an embodiment, the UDM 300 may use the Nudm_SDM_Notification service operation to notify the NF consumer (e.g., AMF) of the update of the subscription data indicated by a subscription data type and additional UDM-related parameters. The Nudm_SDM_Notification service operation may require the subscription data type(s) and a key for each subscription data type as an input. The UDM 300 may invoke the Nudm_SDM_Notification service operation in the following case.
When the subscription data is updated at the UDM 300 (the updated subscription information may be notified to the serving NF that has subscribed for the specific subscription data type to be notified)
When the UDM 300 needs to deliver Steering of Roaming (SoR) information to the UE 100
When the UDM 300 needs to deliver the UDM update data to the UE 100

As described above, the UDM update data may include at least one of a new routing indicator, slice-related credentials (e.g., NSSAA credentials per S-NSSAI), DN-related credentials (e.g., DN-specific credentials for authentication/authorization of PDU session establishment), or the default configured NSSAI to the UE.

When the UDM 300 updates the slice-related credentials, the UDM 300 may, through the UDM update data, request the UE 100 to re-register or request the UE 100 to transmit an ACK for the UDM update data to the UDM 300. When the UDM 300 updates the DN-related credentials, the UDM 300 may, through the UDM update data, request the UE 100 to transmit an ACK for the UDM update data to the UDM 300 or request the UE 100 to re-register.

If the updated subscription information is related to session management, the subscription data may include, for example, allowed PDU session type(s), allowed SSC mode(s), default 5QI (5G QoS Identifier)/ARP (Allocation and Retention Priority), and the like.

Referring to FIG. 1, if the AMF 200 determines that the UE 100 is not reachable, then the AMF 200 may invoke the Nudm_SDM_Info service operation to the UDM 300 indicating that the transmission of the UE parameters update data is not successful (S130). When the UDM 300 finds that the transmission of data for updating the UE parameters is not successful through the Nudm_SDM_Info service operation, the UDM 300 may consider the procedure of the UE parameter update as pending. In this case, the subsequent steps of the procedure of the UE parameter update may be skipped.

When the Nudm_SDM_Info service operation notifying that the transmission of the UE parameter update data has failed is invoked, the UDM 300 may use the UE Reachability Notification Request procedure or UE mobility analytics to determine when to perform the UE parameter update again.

In an embodiment, provisioning of credentials (e.g., NSSAA credentials per S-NSSAI or DN-specific credentials for authentication/authorization of the PDU session establishment) may be required for a service that requires such credentials. The service requiring such credentials may not be provided before the credentials are provisioned and provisioned credentials are verified.

Referring to FIG. 1, the AMF 200 may send a DL NAS TRANSPORT message to the UE 100 (served UE) (S140). A transparent container (i.e., UE parameter update (UPU) container) received from the UDM 300 may be included 200 in the DL NAS TRANSPORT message by the AMF. In an embodiment, the UPU container may include the UE parameters updated by the UDM 300 .

The UE 100 may verify that the UDM update data is provided by HPLMN, SNPN, or CH (security check). If the security check on the UDM update data is successful, the UE 100 may store the received information and use the parameters updated according to the received information from that point onward. Alternatively, if the security check on the UDM update data is successful, the UE 100 may forward the received information to the USIM.

If the security check on the UDM update data fails, the UE 100 may discard the contents of the UDM update data.

If the UE 100 has verifies that the UDM update data is provided by HPLMN, SNPN, or CH and the UDM 300 has requested the UE 100 to send an ack to the UDM 300, the UE 100 may send a UL NAS TRANSPORT message to the serving AMF 200 with a transparent container including the UE acknowledgment S150.

When the AMF 200 receives a UL NAS TRANSPORT message with a transparent container carrying the UE acknowledgment from the UE 100, the AMF 200 may send a Nudm_SDM_Info request message including the transparent container carrying the UE acknowledgment to the UDM 300 (S160).

If UE parameter update is performed due to “routing indicator update data” and UDM 300 has requested the UE to send the ack but does not request re-registration, upon receiving a transparent container indicating the acknowledgment of successful reception, the UDM 300 may trigger the Nudm_SDM_Notification service operation to update the UE context in the AMF 200 with the updated routing indicator data (S170). By triggering the Nudm_SDM_Notification service operation, the UDM 300 may avoid transmitting the expired routing indicator on the UE context transfer.

In an embodiment, when the UDM 300 has updated the DN-related credentials, the UDM 300 may request the UE 100 to transmit an ACK for the UDM update data (“UE acknowledgment requested” indication). If the UDM 300 does not receive the ACK for the UDM update data from the UE 100, the UDM 300 may retransmit the UDM update data to the UE 100 via the AMF 200.

In an embodiment, after the UDM 300 receives the ACK for the UDM update data from the UE 100, the UE 100 may perform an authentication/authorization request for establishing a PDU session with a new DN.

If the UDM 300 has requested the UE 100 to re-register, the UE 100 may wait until it goes back to a radio resource control (RRC) idle state and initiate a registration procedure. The UE 100 may request re-registration to the AMF 200 for re-registration based on the updated UE parameter (alternatively, the UE 100 may transmit the registration request).

In an embodiment, when the UDM 300 updates the slice-related credentials, the UDM 300 may request the UE 100 to re-register (“re-registration requested” indication). For example, the UE 100 may use the slice allowed by the updated UE parameter when requesting re-registration to the AMF 200. When the UE 100 receives an acceptance for the registration request sent to the AMF 200, the UE 100 may send a PDU session establishment request according to the allowed NSSAI included in the registration acceptance to the AMF 200. Here, the S-NSSAI in the PDU session establishment request may include a slice corresponding to the updated slice-related credentials and the S-NSSAI may correspond to the slice-related credentials updated by the UDM 300.

By updating the UE credentials for various purposes through the control plane, it is possible to flexibly support the service to be provided to the UE.

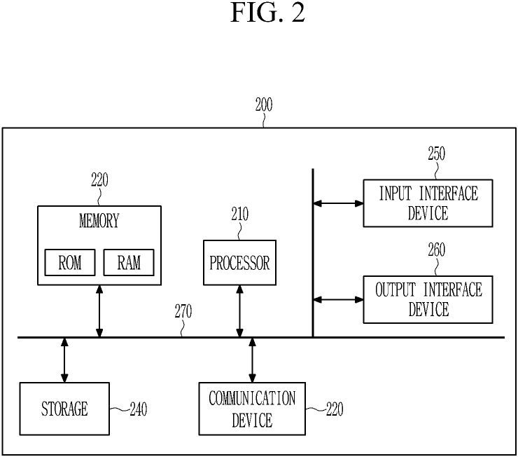

FIG. 2 is a block diagram illustrating a function device according to an embodiment.

The function device according to an embodiment may be implemented as a computer system, for example, a computer-readable medium. Referring to FIG. 2, the computer system 200 may include at least one of a processor 210, a memory 230, an input interface device 250, an output interface device 260, and a storage device 240 communicating through a bus 270. The computer system 200 may also include a communication device 220 coupled to the network. The processor 210 may be a central processing unit (CPU) or a semiconductor device that executes instructions stored in the memory 230 or the storage device 240. The memory 230 and the storage device 240 may include various forms of volatile or nonvolatile storage media. For example, the memory may include read only memory (ROM) or random-access memory (RAM). In the embodiment of the present disclosure, the memory may be located inside or outside the processor, and the memory may be coupled to the processor through various means already known. The memory is a volatile or nonvolatile storage medium of various types, for example, the memory may include read-only memory (ROM) or random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 220 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD—ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above—described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A unified data management function (UDM) in a communication system, the UDM comprising:
a processor, a memory, and a communication device, wherein the processor executes a program stored in the memory to perform:
determining an update of at least one UE parameter of a terminal and updating the UE parameter; and
notifying the updated UE parameter to an access and mobility management function (AMF) connected to the terminal by invoking a service operation for a subscription data management (SDM) notification of the UDM.

2. The UDM of claim 1, wherein
when determining the update of the UE parameter of the terminal, the processor performs
detecting a change of a slice available for the terminal and determining to perform an update of slice-related credentials.

3. The UDM of claim 1, wherein
when determining the update of the UE parameter of the terminal, the processor performs
predicting a level of a service to be provided to the terminal and determining to perform an update of slice-related credentials.

4. The UDM of claim 2, wherein
the slice-related credentials include network slice-specific authentication and authorization (NSSAA) credentials per single-network slice selection assistance information (S-NSSAI).

5. The UDM of claim 1, wherein
when determining the update of the UE parameter of the terminal, the processor performs
detecting a change of a data network (DN) allowed for the terminal and determining to perform an update of DN-related credentials.

6. The UDM of claim 1, wherein
when determining the update of the UE parameter of the terminal, the processor performs
predicting a change of a data network (DN) allowed for the terminal and determining to perform an update of DN-related credentials.

7. The UDM of claim 5, wherein
the DN-related credentials include DN-specific credentials and the DN-specific credentials are credentials for authentication/authorization of a protocol data unit (PDU) session establishment for a predetermined DN used by the terminal.

8. A terminal in a communication system, comprising:
a processor, a memory, and a communication device, wherein the processor executes a program stored in the memory to perform:
receiving update data of at least one UE parameter including updated slice-related credentials from an access and mobility management function (AMF) of a core network in the communication system; and
receiving a service from the core network based on the update data.

9. The terminal of claim 8, wherein
when receiving the service from the core network based on the update data, the processor performs
requesting re-registration to the AMF.

10. The terminal of claim 8, wherein
the processor executes the program to further perform
transmitting an acknowledgment for the update data to a unified data management function (UDM) of the core network via the AMF.

11. The terminal of claim 8, wherein
the slice-related credentials include network slice-specific authentication and authorization (NSSAA) credentials per single NSSAI (S-NSSAI).

12. The terminal of claim 9, wherein
the processor executes the program to further perform
receiving an acceptance for the request of the re-registration from the AMF.

13. The terminal of claim 9, wherein
requested network slice selection assistance information (requested NSSAI) included in the request of the re-registration corresponds to the slice-related credentials.

14. A terminal in a communication system, comprising:
a processor, a memory, and a communication device, wherein the processor executes a program stored in the memory to perform:
receiving update data of at least one UE parameter including updated data network (DN)-related credentials from an access and mobility management function (AMF) of a core network in the communication system; and
receiving a service from the core network based on the update data.

15. The terminal of claim 14, wherein
the processor executes the program to further perform
transmitting an acknowledgment for the update data to a unified data management function (UDM) of the core network via the AMF.

16. The terminal of claim 14, wherein
the DN-related credentials include DN-specific credentials for authentication/authorization of protocol data unit (PDU) session establishment for a predetermined DN used by the terminal.

17. The terminal of claim 16, wherein
when receiving the service from the core network based on the update data, the processor performs
transmitting a request for authentication/authorization of the PDU session establishment to the DN corresponding to the DN-related credentials.

18. The terminal of claim 14, wherein
when receiving the service from the core network based on the update data, the processor performs
requesting re-registration to the AMF.

19. The term inal of claim 18, wherein
the processor executes the program to further perform
receiving an acceptance for the request of the re-registration from the AMF.
